(19) United States
(12) Patent Application Publication
(10) Pub. No.: US 2010/0031554 A1
(43) Pub. Date: Feb. 11, 2010

(54) Plastic fishing cork

(76) Inventors: Gerald D. Brooks, JR., Victoria, TX (US); Gerald D. Brooks, SR., Bishop, TX (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/222,513

(22) Filed: Aug. 11, 2008

(51) Int. Cl. A01K 93/00; A01K 85/01

(52) U.S. Cl. 43/44.87; 43/42.31

(57) ABSTRACT

The plastic fishing cork is a bobber or float having the shape of an inverted cone. The fishing cork tapers to a point at the lower end, and has a concave upper surface for generating a “popping” noise to attract fish when a fisherman jerks the line. A ring for connecting the fishing cork to the fishing line is centered on the concave upper surface. The fishing cork has a second ring is attached on the lower point of the fishing cork for connecting to a leader holding the hook and bait. The plastic fishing cork has a hollow interior chamber that contains a plurality of rattle chambers that attract the attention of a fish.

### BACKGROUND OF THE INVENTION

1. Field of the Invention

The present invention relates to fishing floats and bobbers, and more particularly to a plastic fishing cork shaped like an inverted cone with a concave top surface to make a popping noise and having an interior chamber containing rattles to attract fish.

2. Description of the Related Art

The use of floats and bobbers while fishing is well known. Generally, a fisherman rigs a fishing line with a float, sinker weight and hook. The float or bobber is positioned on the line according to the desired depth of fishing. The bobber, which is made of a material such as cork or plastic, floats on the surface and keeps the baited hook from sinking to the bottom, and maintains the hook and bait at a fixed depth in the water. The up and down motion of the bobber indicates that a fish has taken the bait.

There are various types of floats commonly available, and the type of float that is used is often dependant on the weather conditions and type of fish being sought. If a fisherman is casting many feet from the shoreline or a boat, then visibility of the part of the float that remains on the surface of the water becomes important. Floats that are brightly colored or long floats that extend several inches above the water will most likely be chosen. Turbulent water conditions because of wind or wave action will likely necessitate the use of a float that is relatively insensitive to such movements. Normally, this would require using a float with a weighted bottom that forces the float to remain upright in the water.

The size of the fish likely to be caught also influences the selection of the float. A larger or stronger fish will very noticeably move the float when it strikes. A smaller fish will only slightly move the float unless the float is very sensitive.

Often, corks, floats or bobbers are used in conjunction with live bait, as their natural movements are attractive to fish. Fish, especially some saltwater fish, are attracted by noise. The use of rattles and other noisemaking devices are often used when seeking these types of fish. For example, one of the top baits for sea trout or weakfish is a live shrimp hooked through the head or tail and cast out so that it will swim around a few feet below the surface. A cork float or bobber can be used a short distance above the hook. This can often be “popped” or jerked so that it throws a splash that attracts fish to the scene. There are special rods and reels specifically made for this type of fishing, and are very commonly used in the Gulf of Mexico off of the Texas coast.

While bobbers and floats made from cork work well for this type of fishing, corks deteriorate after repeated use and exposure. There is a need therefore, for a plastic fishing cork that has integral noisemaking properties and durability. Thus, a plastic fishing cork solving the aforementioned problems is desired.

### SUMMARY OF THE INVENTION

The plastic fishing cork is a bobber or float having the shape of an inverted cone. The fishing cork tapers to a point at the lower end, and has a concave upper surface for generating a “popping” noise to attract fish when a fisherman jerks the line. A ring for connecting the fishing cork to the fishing line is centered on the concave upper surface. The fishing cork has a second ring is attached on the lower point of the fishing cork for connecting to a leader holding the hook and bait. The plastic fishing cork has a hollow interior chamber that contains a plurality of rattle chambers that attract the attention of a fish. Metallic spherical balls such as ball bearings may also be used. The plastic fishing cork is placed a short distance above a fishhook and cast out from a boat or shoreline. Live bait, such as a shrimp that is hooked through the tail or head, will then be free to swim a few feet below the surface. The rattle chambers in the interior make noise because of the motion of the fishing cork in the water, and the concave surface creates a “popping” sound and a splash that can also attract the attention of a fish.

These and other features of the present invention will become readily apparent upon further review of the following specification and drawings.

### BRIEF DESCRIPTION OF THE DRAWINGS

FIG. 1 is an environmental, perspective view of a plastic fishing cork according to the present invention.

FIG. 2 is a side view in section of a plastic fishing cork according to the present invention.

Similar reference characters denote corresponding features consistently throughout the attached drawings.

### DETAILED DESCRIPTION OF THE PREFERRED EMBODIMENTS

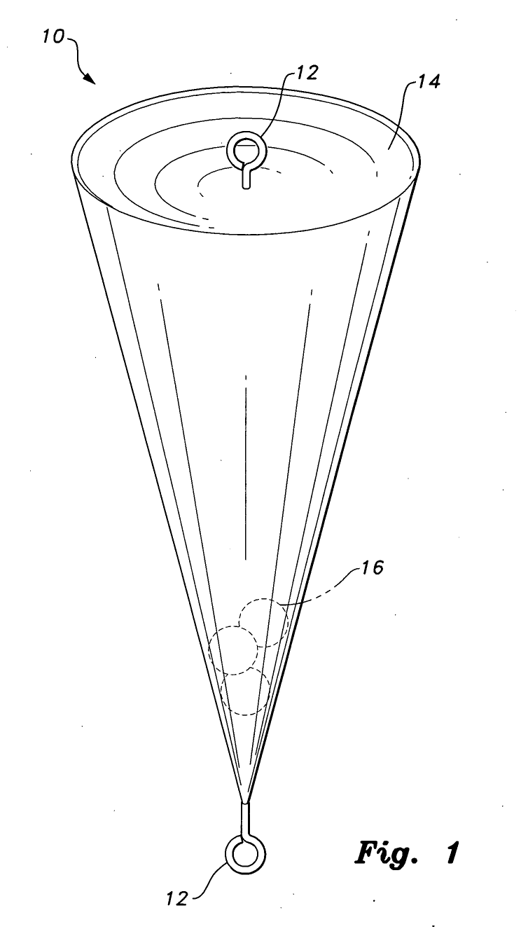

The present invention is a plastic fishing cork, shown in FIG. 1 in perspective view and designated as 10. The plastic fishing cork 10 has a floating body shaped like an inverted cone. A concave upper surface 14 makes a “popping” sound and a splash when the fishing line is jerked. An upper ring 12 attached at the center of the concave upper surface 14 is adapted for attaching to a fishing line. A lower ring 12 connected at the lower end of the plastic fishing cork 10 is adapted for attaching to a leader containing a fish hook and bait or a fishing lure. The hollow interior chamber contains a plurality of rattle chambers 16, shown in phantom. In an alternative embodiment, small metallic spherical balls, such as ball bearings, may be used. The spherical balls or rattle chambers 16 make a rattling sound because of the movement of the plastic fishing cork 10 in the water.

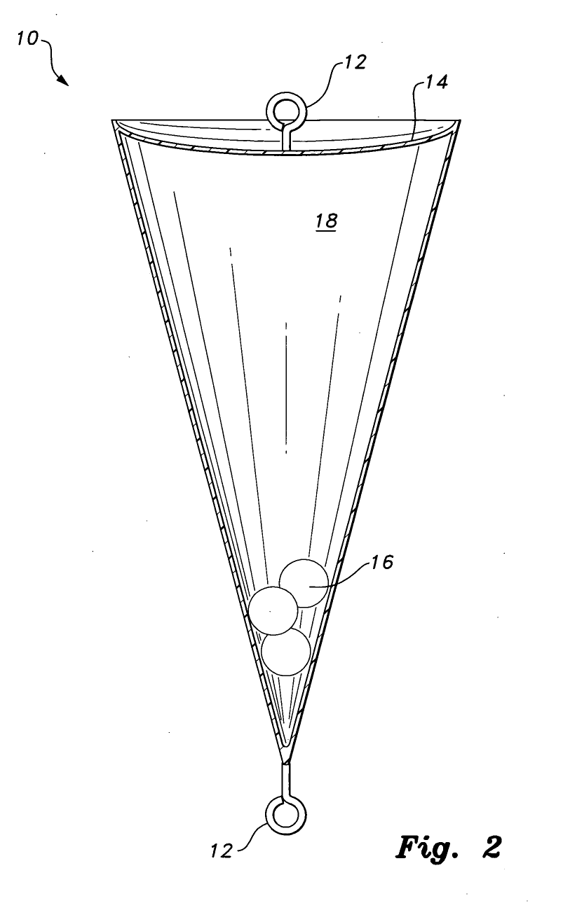

FIG. 2 is a longitudinal cross section of the plastic fishing cork 10, showing the hollow interior chamber 18 containing a plurality of rattle chambers 16. The plastic fishing cork 10 is preferably made from a plastic such as polypropylene foam or a similar material that will not deteriorate after repeated use or when stored in a tackle box. The plastic fishing cork preferably has a white or light colored body and a florescent orange or similar color for the top concave surface 14, for enhanced visibility in low light or turbulent conditions.

It is to be understood that the present invention is not limited to the embodiments described above, but encompasses any and all embodiments within the scope of the following claims.

We claim:

1. A plastic fishing cork, comprising:
a buoyant body adapted for connection to a fishing line, the body being formed in the shape of an inverted cone having a lower point and a concave upper surface having a center, the body defining an interior chamber;
an upper ring member defining a first eye for attaching a fishing line thereto, the upper ring member extending from the center of the upper concave surface of the buoyant body;
a lower ring member defining a second eye for attaching a leader line thereto, the lower ring member extending from the lower point of the buoyant body; and
a plurality of noisemaking bodies disposed within the interior chamber.

2. The plastic fishing cork according to claim 1, wherein the noisemaking bodies comprise rattle chambers.

3. The plastic fishing cork according to claim 1, wherein the noisemaking bodies comprise metallic spherical balls.
